(19) United States
(12) Patent Application Publication
(10) Pub. No.: US 2006/0016855 A1
(43) Pub. Date: Jan. 26, 2006

(54) Strap bonding machine and method of manufacturing a semiconductor device

(75) Inventors: Shigeru Tanabe, Hyogo-ken (JP); Masataka Namba, Hyogo-ken (JP); Kaoru Nakamura, Hyogo-ken (JP); Kosuke Tosa, Hyogo-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/179,596

(22) Filed: Jul. 13, 2005

(30) Foreign Application Priority Data
Jul. 22, 2004 (JP) 2004-213756

(51) Int. Cl. B23K 37/00

(52) U.S. Cl. 228/6.2; 228/4.1; 228/5.7

(57) ABSTRACT

There is provided a strap-bonding machine, including a metal ribbon tape storage portion configured to hold a metal ribbon tape, a metal ribbon tape-cutting portion configured to cut the metal ribbon tape fed from the metal ribbon tape storage portion to a metal strap having a predefined shape, a metal strap-carrying portion configured to feed the metal strap to a picking-position, a lead frame-carrying portion configured to carry a lead frame mounted a semiconductor chip on and having a lead terminal, and a bonding portion configured to pick up the metal strap at the picking-position, to carry the metal strap above the lead frame and to bond the metal strap to the semiconductor chip and the lead terminal.

### CROSS REFERENCE TO RELATED APPLICATION

This application is based upon and claims the benefit of priority from the prior Japanese Patent Application No. JP2004-213756, filed on Jul. 22, 2004; the entire contents of which are incorporated herein by reference.

### FIELD OF THE INVENTION

The present invention relates to a strap bonding machine and a method of manufacturing a semiconductor device, and in particular, to a strap bonding machine and a strap bonding method electrically connecting between a semiconductor chip and a lead terminal using a metal strap formed by cutting out a metal ribbon tape.

### DESCRIPTION OF THE BACKGROUND

In recent MOSFET and IGBT for an application to a power semiconductor device, a strap conductor made of Al or Cu has been used for electrically connecting between a semiconductor chip and a lead terminal instead of a wire bonding technique using high cost materials such as Au. For example, a strap bonding technique is described in Japanese Patent Publication (Kokai) No. JP2002-314018, P20, FIG. 15. The strap bonding technique mentioned in the above reference can lead to reduction of a cost on the device, lowering resistance and preventing the conductor from disconnecting.

As comparing with the conventional wire bonding in which an Au wire or an Al wire is bonded to a semiconductor chip, the strap bonding technique has a shortage such as a comparatively low speed operation. Therefore, the strap bonding technique has an issue on production efficiency. On the other hand, another issue on the strap bonding technique is to simplify a construction of a strap bonding machine.

### SUMMARY OF THE INVENTION

According to an aspect of the invention, there is provided a strap-bonding machine, including a metal ribbon tape storage portion configured to hold a metal ribbon tape, a metal ribbon tape-cutting portion configured to cut the metal ribbon tape fed from the metal ribbon tape storage portion to a metal strap having a predefined shape, a metal strap-carrying portion configured to feed the metal strap to a picking-position, a lead frame-carrying portion configured to carry a lead frame mounted a semiconductor chip on and having a lead terminal, and a bonding portion configured to pick up the metal strap at the picking-position, to carry the metal strap above the lead frame and to bond the metal strap to the semiconductor chip and the lead terminal.

Further, according to another aspect of the invention, there is provided a strap bonding machine, including a metal ribbon tape storage portion configured to hold a metal ribbon tape, a metal ribbon tape-cutting portion configured to include a lead connection area and a chip connection area, to process a metal ribbon tape as a loop-like shape in height direction between the lead connection area and the chip connection area, to cut the metal ribbon tape to a metal strap having the loop-like shape, a metal strap-carrying portion configured to feed the metal strap to a picking-position, a lead frame-carrying portion configured to carry a lead frame mounted a semiconductor chip on and having a lead terminal, and a bonding portion configured to pick up the metal strap and to bond the metal strap to the semiconductor chip and the lead terminal.

Further, according to another aspect of the invention, there is provided a method of manufacturing a semiconductor device, including cutting a metal ribbon tape to a metal strap having a predefined shape, carrying the metal strap to a picking-position, carrying a lead frame mounted a semiconductor chip on and having a lead terminal to a bonding portion, picking up the metal strap, carrying the metal strap to the bonding portion, and bonding the metal strap to the semiconductor chip and the lead terminal.

### BRIEF DESCRIPTION OF THE DRAWINGS

FIG. 1 is a front view showing an Al strap bonding machine in a first embodiment of the present invention;

FIG. 2 is a plan view showing a bonding portion in the first embodiment of the present invention;

FIG. 3 is a schematic diagram showing a manufacturing process steps of a semiconductor device by using the Al strap bonding machine in the first embodiment of the present invention;

FIG. 4 is a perspective view showing an Al strap in a second embodiment of the present invention; and

FIG. 5 is a block diagram showing a motion of a strap-carrying portion in the second embodiment of the present invention.

### DETAILED DESCRIPTION OF THE INVENTION

Embodiments of the present invention will be described hereinafter in detail with reference to the drawings mentioned above.

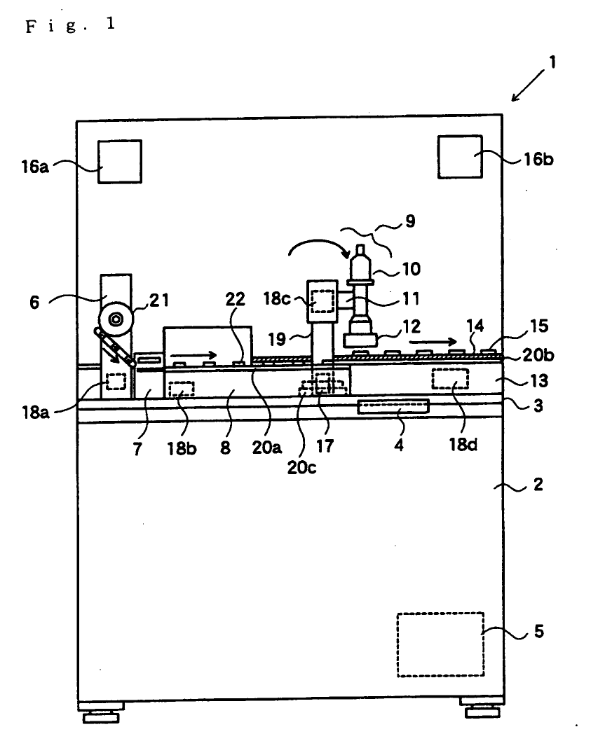

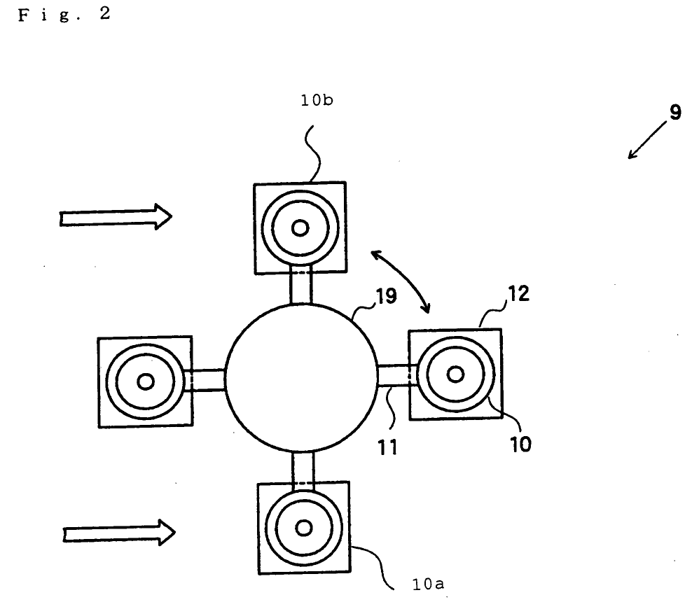

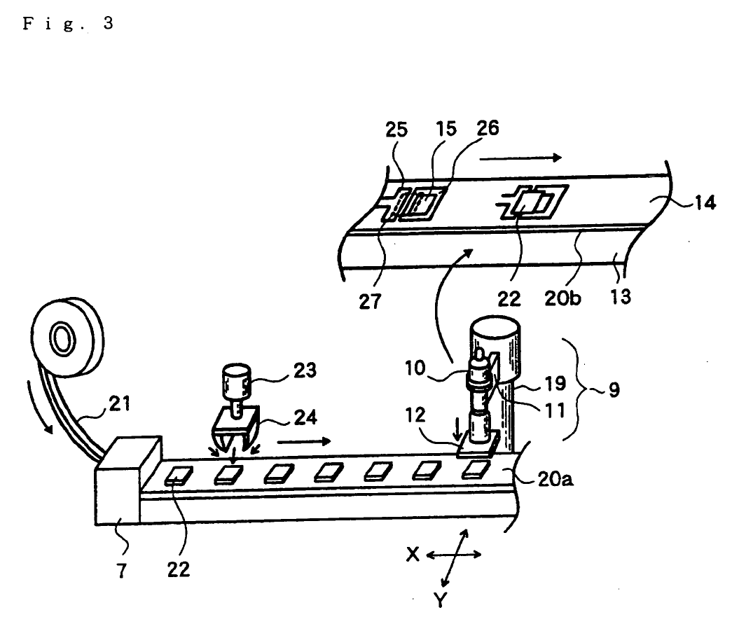

First, according to a first embodiment of the present invention, a strap bonding machine and a strap bonding method are explained with reference to FIGS. 1-3. FIG. 1 is a front view showing an Al strap bonding machine. FIG. 2 is a plan view showing a bonding portion. FIG. 3 is a schematic diagram showing a motion on the Al strap bonding machine.

As shown in FIG. 1, an Al strap bonding machine 1 has a mount 2, a base 3, an operation panel portion 4, a control portion 5, an Al ribbon tape storage portion 6, an Al ribbon tape-cutting portion 7, an Al strap-carrying portion 8, a bonding portion 9, a lead frame-carrying portion 13 and image monitors 16a, 16b. The Al strap bonding machine 1 electrically connects an Al strap 22 to electrodes of a power semiconductor chip 15 and lead terminals disposed on a lead frame 14.

The base 3 and the operation panel portion 4 disposed on the mount 2. The control portion 5 is put in the lower right portion of the mount 2. Data operated in the operation panel portion 4 is addressed into the control portion 5. The control portion 5 sends control signals to the Al ribbon tape storage portion 6, the Al ribbon tape-cutting portion 7, the Al strap carrying-portion 8, the bonding portion 9 and the lead frame-carrying portion 13. The control signals control behavior of those potions.

The Al ribbon tape storage portion 6 has an Al ribbon tape 21 like reel and a motor 18a. The motor 18a controlled by the signals addressed from the control portion 5 makes the Al ribbon tape 21 feed to the Al ribbon tape cutting portion 7. The Al ribbon tape-cutting portion 7 cut out the Al ribbon tape 21 to a plurality of Al straps 22 with a predefined shape. The Al strap-carrying portion 8 has a motor 18b and a carrying stage 20a. The motor 18b operated by signals addressed from the control portion 5 makes the Al strap 22 feed to the carrying stage 20a.

The bonding portion 9 has a bonding head 10, an arm 11, an absorption head 12, a high frequency power supply 17, a motor 18c and a head supporting portion 19. The absorption head 12 picks up the Al strap 22 by the signals addressed from the control portion 5. The Al strap 22 is disposed above the surface between electrodes of a power semiconductor chip 15 and a lead terminal and is connected to the electrode and the lead terminal.

The lead frame-carrying portion 13 has a motor 18d and a carrying stage 20b. The carrying stage 20b received signals from the control portion 5 feeds the lead frame 14 from outside the lead frame-carrying portion 13. On the other hand, the carrying stage 20a of the Al strap carrying portion 8 adjusts X-axis and Y-axis directions so as to correct the position of the Al strap 22. The carrying stage 20b of the lead frame-carrying portion 13 adjusts X-axis and Y-axis directions so as to correct the position of the semiconductor chip 15 disposed on the lead frame 14. An X-Y stage 20c disposed on a connection head in the bonding portion 9 adjusts X-axis and Y-axis directions so as to correct an absorption position (picking-position) and a connection position of the Al strap 22.

The image monitor 16a monitors a motion of the Al strap carrying portion 8 and inspects the lead frame 14 and the power semiconductor chip 15. The image monitor 16b monitors a motion of the bonding portion 9 and the lead frame carrying portion 13 and inspects the power semiconductor chip 15 and the Al strap 22. In addition, the operation panel portion 4 can change and extend the monitor position monitored by using the image monitors 16a, 16b.

As shown in FIG. 2, the bonding portion 9 has four bonding heads 10. Each of the bonding head 10 picks up the Al strap (not illustrated) at a bonding head position 10a and move the Al strap to a bonding head position 10b. Moreover, the Al strap is connected to a power semiconductor chip (not illustrated). After finishing the connection, the bonding head 10 moves again to the bonding head position 10a. About a bonding head number, the singular number or plural are available.

A manufacturing process steps of a semiconductor device by using the Al strap bonding machine 1 is shown a in FIG. 3. First, the Al ribbon tape 21 fed from the Al ribbon tape storage portion (not illustrated) is cut in rectangles at the Al ribbon tape cutting portion 7, so that the plurality of Al straps 22 is formed.

The position of the Al strap 22 on the carrying stage 20a is corrected by using a holding portion 23. For a position correction method, a camera et al. (not illustrated) recognizes the Al strap 22 for adjusting to an Al strap image predominantly memorized in the control portion as shown in FIG. 1.

The Al strap 22 is descended down by the holding portion 23 and is carried at the predetermined position by movement to X-direction and Y-direction of a holding piece 24 and rotation of the holding piece 24. A rubber or the like having less hardness than that of Al, may set on a part of the holding piece 24 contacting with the Al strap 22. A material with higher hardness can be applied for the rubber, if necessary.

Next, the Al strap 22 on the carrying stage 20a is picked up. A camera or the like (not illustrated) is employed for observation of Al strap 22 in picking process. The bonding head 10 is carried at the position just above the Al strap 22 by movement to X-direction and Y-direction of the absorption head 12 and rotation of the absorption head 12.

The Al strap 22 is descended down by the bonding head 10 and is picked up by the absorption head 12. The bonding head 10 holding the Al strap is rotated. The Al strap 22 is disposed on the connection portion 27 of the lead frame 14. Ultrasonic wave generated by the high frequency power supply 17 bonds the Al strap 22 to a lead terminal 25 and a head 26, so as to electrically connect between the lead terminal 25 and the power semiconductor chip 15 on the head 26.

As mentioned in the first embodiment of the strap bonding machine and the method of manufacturing the semiconductor device, the Al ribbon tape 21 like a reel is cut out a plurality of the Al straps 22 as predefined. A plurality of Al straps 22 are serially picked up by a plurality of bonding heads 10. The ultrasonic wave technique electrically connects between electrodes of the power semiconductor chip 15 and the lead terminal. Therefore, the bonding operation has higher speed as comparing with cutting the Al ribbon tape 21 at the bonding head.

Furthermore, as the cutting apparatus on the Al ribbon tape 21 is separated from the picking mechanism on the bonding head 10 and ultrasonic wave mechanism, the bonding head becomes simply and lightly. This means that the machine operation having higher speed can be realized without generation of troubles and failures in this embodiment. As a result, high efficient bonding technique can be obtained.

In this embodiment, the Al strap 22 is connected between electrodes of the power semiconductor chip 15 and the lead terminal 25 by ultrasonic wave technique, however, the Al strap 22 may be welded by using lump heating technique.

As mentioned above, this embodiment can provide a strap bonding machine having simplified structure and a strap bonding method with high speed operation.

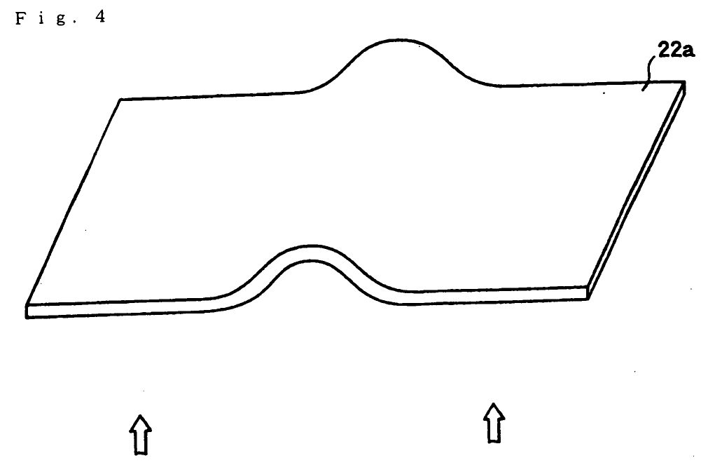

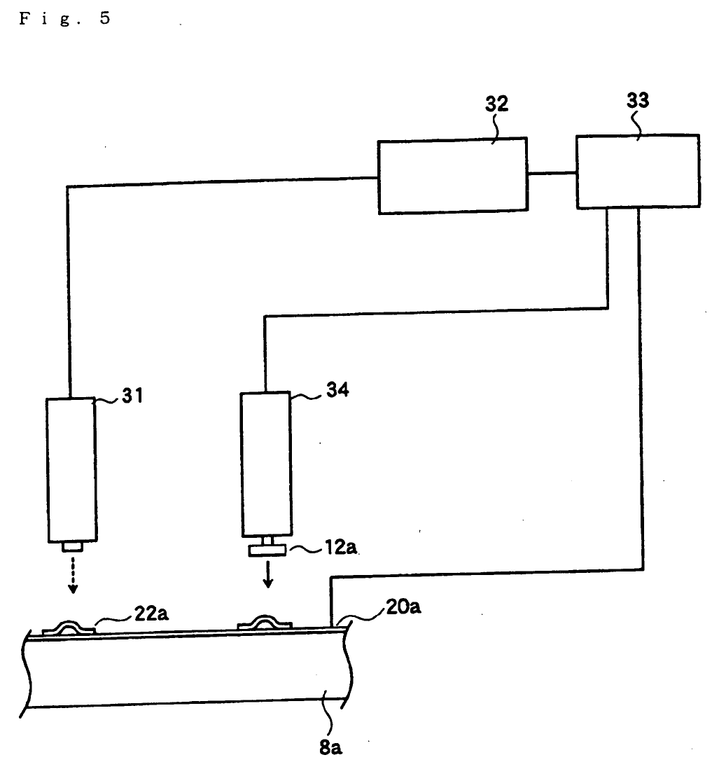

Next, according to a second embodiment of the present invention, a strap bonding machine and a method of manufacturing a semiconductor device are explained with reference to FIG. 4-5. FIG. 4 is a perspective view showing an Al strap. FIG. 5 is a block diagram showing a motion of a strap-carrying portion.

In the second embodiment, a portion of a same composition as the first embodiment is attached the same number and explanation of the portion of the same composition is omitted.

As shown in FIG. 4, an Al strap 22a has a loop-like shape. This leads improvement of adhesion between a molding resin and the Al strap 22a in subsequent processes, so that reliability of a resin-molded semiconductor device is increased.

FIG. 5 shows a motion of an Al strap-carrying portion 8a. First, the Al ribbon tape 21 (not illustrated) fed from the Al ribbon tape storage portion (not illustrated) is cut out at the Al ribbon tape cutting portion 7, so as to be formed a plurality of Al straps 22a as described in the first embodiment.

A position and shape detect portion 31 set up such as a TV camera detects position data and shape data on the Al strap 22a. The data are addressed to a cognition portion 32. The cognition portion 32 recognizes and memorizes the data. The calculation portion 33 comparatively calculates position data and shape data of the Al strap 22a memorized in the cognition portion 32. Furthermore, position data and shape data of a standard sample of an Al strap preliminarily memorized also in the cognition portion 32. On the basis of the position data comparatively calculated at the calculation portion 33, an absorption head 12a of a position-adjusting portion 34 is moved to X-direction and Y-direction and is rotated. After the position-adjusting portion 34 is descended down, the absorption head 12a picks up the Al strap 22a.

When the shape of the Al strap 22a is not preliminarily determined the position-adjusting portion 34 received signals from the calculation portion 33 picks up the Al strap 22a. Moreover, the position-adjusting portion 34 carries the Al strap 22a out of the carrying stage 20a. A shape of an absorption head 12a may have a slope like the Al strap 22a, the slope makes the absorption head 12a easily pick up the Al strap 22a.

The Al strap 22a is set on a carrier tray (not illustrated) disposed on the carrying stage 20a. Here, a shape of the carrier tray may have a slope like the Al strap 22a.

Finally, the Al strap 22a on the carrier tray is picked up and is connected to a lead terminal and a power semiconductor by using ultrasonic wave technique. Here, a shape of the absorption head 12 may have a slope like the Al strap 22a.

As mentioned above, the Al strap 22a is picked up at the prescribed position and is connected by ultrasonic wave technique in the strap bonding machine and the method of manufacturing the semiconductor device in the second embodiment. Therefore, the Al strap carrying portion 8a has the position and shape detect portion 31, the cognition portion 32, the calculation portion 33 and the position adjust portion 34. A bonding process using the Al strap 22a with a complicated shape also has advantages same as the first embodiment has.

The second embodiment on bonding a metal strap to a semiconductor chip can provide a strap bonding machine having a simple configuration and a method of manufacturing a semiconductor device including a high speed operation.

Other embodiments of the present invention will be apparent to those skilled in the art from consideration of the specification and practice of the invention disclosed herein. It is intended that the specification and example embodiments be considered as exemplary only, with a true scope and spirit of the invention being indicated by the claims that follow. The invention can be carried out by being variously modified within a range not deviated from the gist of the invention.

For example, the method in the embodiments is applied to the strap bonding machine using an Al-strap, however, the method can be also applied to a strap bonding machine using a Cu-strap or an Au-strap.

Moreover, the method and the machine can be also applied to series of lead frames. The height of a lead connection area may have different height against a chip connection area.

What is claimed is:

1. A strap bonding machine, comprising:
a metal ribbon tape storage portion configured to hold a metal ribbon tape;
a metal ribbon tape-cutting portion configured to cut the metal ribbon tape fed from the metal ribbon tape storage portion to a metal strap having a predefined shape;
a metal strap-carrying portion configured to feed the metal strap to a picking-position;
a lead frame-carrying portion configured to carry a lead frame mounted a semiconductor chip on and having a lead terminal; and
a bonding portion configured to pick up the metal strap at the picking-position, to carry the metal strap above the lead frame and to bond the metal strap to the semiconductor chip and the lead terminal.

2. The strap bonding machine according to claim 1, wherein the bonding portion includes a plurality of bonding heads to bond the metal strap to the semiconductor chip and the lead terminal.

3. The strap bonding machine according to claim 1, further comprising a position-adjusting portion configured to adjust the metal strap on the metal strap-carrying portion to a prescribed position.

4. The strap bonding machine according to claim 3, further comprising a holding portion as the position-adjusting portion.

5. The strap bonding machine according to claim 1, further comprising an ultrasonic generation apparatus for bonding the metal strap.

6. The strap bonding machine according to claim 1, wherein the metal ribbon tape is Al, Cu or Au.

7. A strap bonding machine, comprising:
a metal ribbon tape storage portion configured to hold a metal ribbon tape;
a metal ribbon tape-cutting portion configured to include a lead connection area and a chip connection area, to process a metal ribbon tape as a loop-like shape in height direction between the lead connection area and the chip connection area, to cut the metal ribbon tape to a metal strap having the loop-like shape;
a metal strap-carrying portion configured to feed the metal strap to a picking-position;
a lead frame-carrying portion configured to carry a lead frame mounted a semiconductor chip on and having a lead terminal; and
a bonding portion configured to pick up the metal strap and to bond the metal strap to the semiconductor chip and the lead terminal.

8. The strap bonding machine according to claim 7, further comprising a position-adjusting portion configured to adjust the metal strap on the metal strap-carrying portion to a prescribed position.

9. The strap bonding machine according to claim 7, further comprising a holding portion as the position-adjusting portion.

10. The strap bonding machine according to claim 7, further comprising an ultrasonic generation apparatus for bonding the metal strap.

11. The strap bonding machine according to claim 7, wherein the metal ribbon tape is Al, Cu or Au.

12. A method for manufacturing a semiconductor device, comprising:
cutting a metal ribbon tape to a metal strap having a predefined shape;
carrying the metal strap to a picking-position;
carrying a lead frame mounted a semiconductor chip on and having a lead terminal to a bonding portion;
picking up the metal strap;
carrying the metal strap to the bonding portion; and
bonding the metal strap to the semiconductor chip and the lead terminal.

13. The method for manufacturing the semiconductor device according to claim 12, wherein the metal ribbon tape is processed to form a loop-like shape in height direction and is subsequently cut to the metal strap having the loop-like shape.
